(19) United States
(12) Patent Application Publication
(10) Pub. No.: US 2018/0002648 A1
(43) Pub. Date: Jan. 4, 2018

(54) Electric Brewing System

(71) Applicant: Colorado Brewing Systems, LLC, Fort Collins, CO (US)

(72) Inventor: Timothy Moore, Fort Collins, CO (US)

(21) Appl. No.: 15/703,778

(22) Filed: Sep. 13, 2017

Related U.S. Application Data
(63) Continuation-in-part of application No. 29/566,618, filed on Jun. 1, 2016, now abandoned.

(51) Int. Cl. C12C 7/04; C12C 1/02; C12C 13/02; C12C 11/00; B01D 3/00

(52) U.S. Cl. CPC C12C 7/04; C12C 1/02; C12C 13/02; B01D 3/001; C12C 11/006

(57) ABSTRACT

An electric brewing system uses kettles, strainer buckets, a support frame, and winches to create a multicomponent system for brewing beer. The kettles are containers used to hold and boil brewing beer. Each kettle has a main valve, a recirculation valve, a whirlpool-inducing recirculation pipe, and a heating element. The main valve and the recirculation valve are integrated into the kettle so that beer stored within the kettle can flow through the main valve and the recirculation valve. The whirlpool-inducing recirculation pipe is a uniquely shaped pipe that is mounted onto the kettle. Additionally, the whirlpool-inducing recirculation pipe causes the beer stored within the kettle to produce a whirlpool while brewing. The heating element is mounted within the kettle and is used to increase the temperature of the beer. The kettles and the winches are mounted onto the support frame and the strainer buckets are tethered to the winches.

### FIELD OF THE INVENTION

The present invention relates generally to a system for brewing beer. More Particularly, the present invention relates to a brewing system that employs a brewing kettle with multiple valves and a whirlpool-inducing recirculation pipe.

### BACKGROUND OF THE INVENTION

There are many methods and recipes for brewing beer. The traditional methods often involve multistep processes that require a brewer to stick to a strict schedule. This often results in amateur brewers ruining entire batches by simply waiting too long to perform a certain step or allowing the brewing kettle to exceed an optimal temperature. More experienced brewers are able to produce reliably good beer, yet they are constantly looking for methods to increase the efficiency and easy of the brewing process.

The present invention, the electric brewing system, enables brewers to make reliably good bear by using an electronic control system to automate many steps of the brewing process. Additionally, the present invention makes use of a whirlpool-inducing recirculation pipe to facilitate increased mash efficiencies. These features improve ease of brewing as well as the overall quality of the beer produced.

### BRIEF DESCRIPTION OF THE DRAWINGS

FIG. 1 is a perspective view of the present invention.

FIG. 2 is a front view of the present invention.

FIG. 3 is a perspective view of a single kettle used in the present invention.

FIG. 4 is a top view of a single kettle used in the present invention.

FIG. 5 is a perspective view of a single strainer bucket used in the present invention.

FIG. 6 is a bottom view of a single strainer bucket used in the present invention.

FIG. 7 is a perspective view of the whirlpool-inducing recirculation pipe used in the present invention.

FIG. 8 is a block diagram showing the electronic connections between the components of the present invention; in this view, dashed lines indicate electronic connections.

FIG. 9 is a block diagram showing the electronic connections between the components of the present invention; in this view, dashed lines indicate electronic connections.

FIG. 10 is a block diagram showing the flow of beer during one step of the brewing process used by the present invention; in this view, bold lines indicate fluid communication.

FIG. 11 is a block diagram showing the flow of beer during a different step of the brewing process used by the present invention; in this view, bold lines indicate fluid communication.

FIG. 12 is a block diagram showing the flow of beer out of the interior cavity, through the recirculation pump, through the refrigeration unit, and into an external container used in the present invention; in this view, bold lines indicate fluid communication.

### DETAIL DESCRIPTIONS OF THE INVENTION

All illustrations of the drawings are for the purpose of describing selected versions of the present invention and are not intended to limit the scope of the present invention.

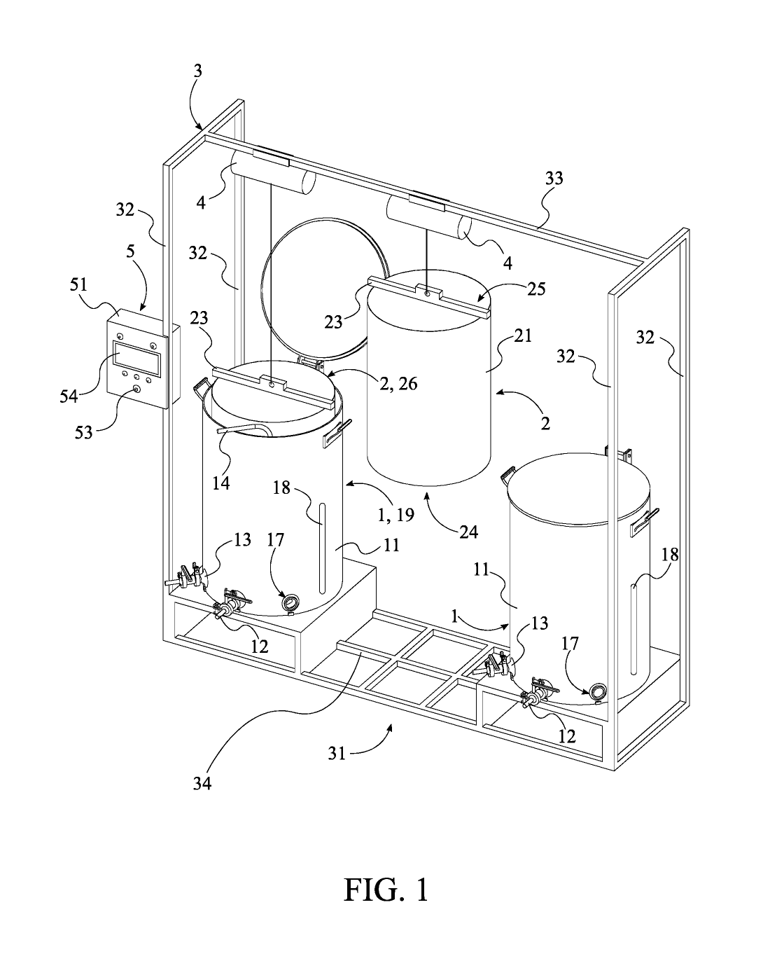

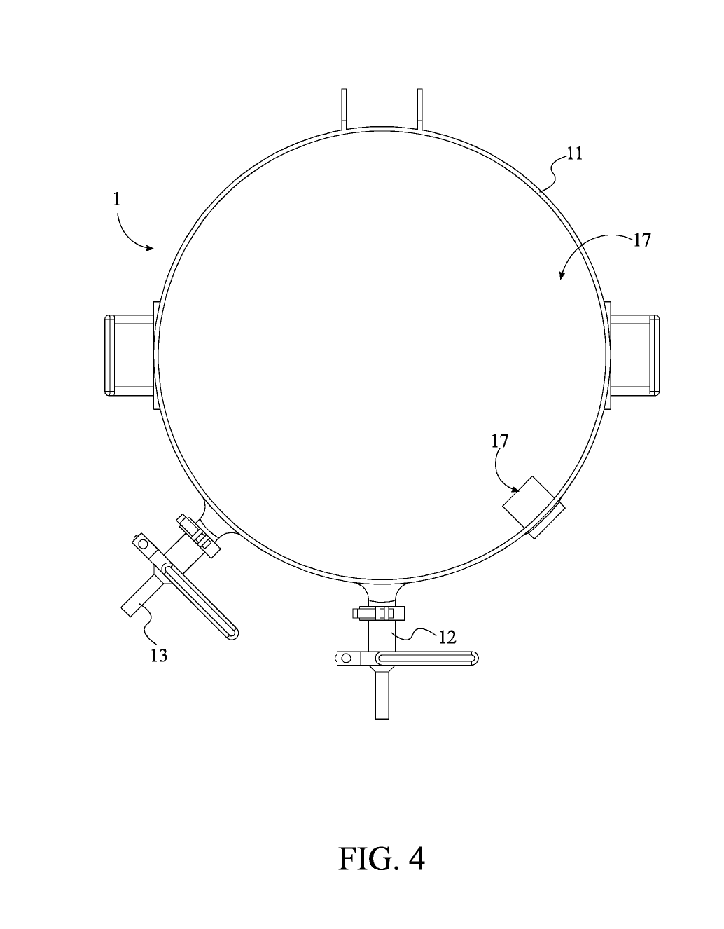

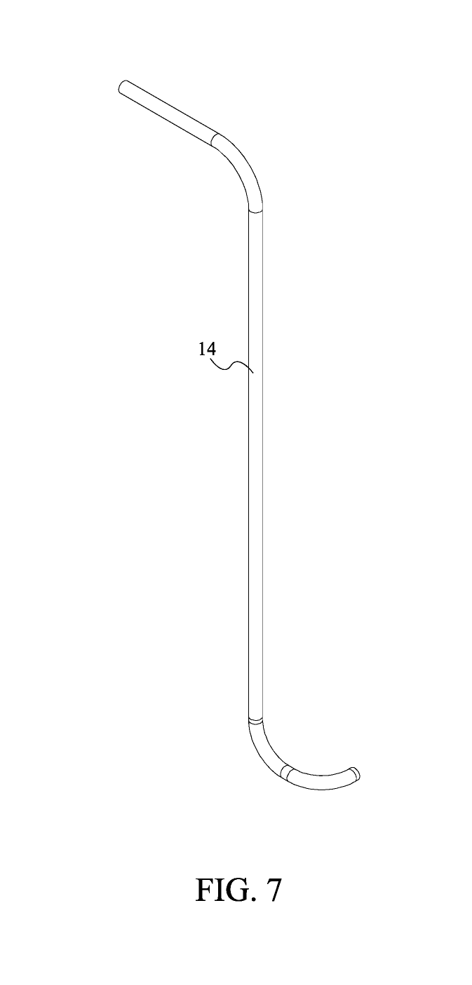

As can be seen in FIG. 1 through FIG. 12, the preferred embodiment of the present invention, the electronic brewing system, is a system that uses an electronic controller to automate the functions of a proprietary brewing kettle. The present invention is designed to be a modular system that enables the user to employ one or more brewing kettle while switching components between various brewing kettles interchangeably. To accomplish this, each brewing kettle is equipped with the components required to heat, separate, and cool batches of beer. Specifically, each brewing kettle comprises a kettle, a strainer bucket, a recirculation valve system, and a whirlpool-inducing recirculation piping system. These components enable the user to achieve consistently high levels of production efficiency. Each brewing kettle can be connected to a dedicated pump, or a single pump may be shared between multiple brewing kettles. Furthermore, operations such as pumping intervals, heating, and cooking time are automated by the electronic controller so that the user is able to streamline the entire process and to reproduce desirable brewing conditions.

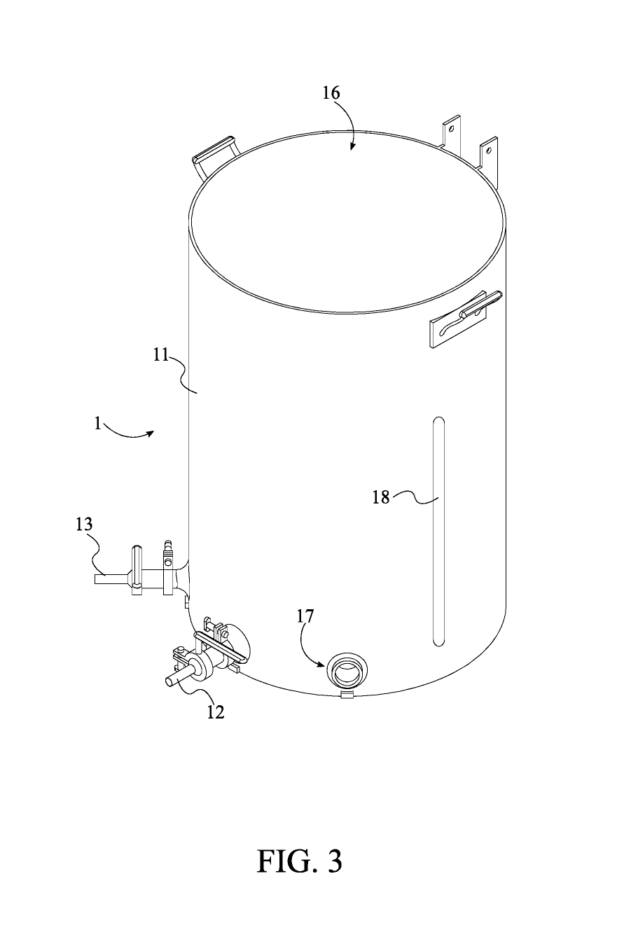

As can be seen in FIG. 1 and FIG. 3, the present invention achieves the above-described functionalities by integrating modified brewing kettles into a multicomponent brewing system. Specifically, the multicomponent system claimed by present invention comprises a plurality of kettles 1, a plurality of strainer buckets 2, a support frame 3, and a plurality of winches 4. Each of the plurality of kettles 1 is a pot that is used for brewing beer. Additionally, each of the plurality of kettles 1 comprises a kettle body 11, a main valve 12, a recirculation valve 13, a whirlpool-inducing recirculation pipe 14, and a heating element 15. The kettle body 11 is the rigid structural foundation of each of the plurality of kettles 1, giving each of the plurality of kettles 1 its shape. The main valve 12 and the recirculation valve 13 are used to move fluids into and out of the kettle body 11. Specifically, the main valve 12 and the recirculation valve 13 are integrated into the kettle body 11. As a result, the user is able to connect various external devices, such as hoses and pumps, to the kettle body 11. The whirlpool-inducing recirculation pipe 14 is a pipe that has an inlet end and a curved outlet end. The curved outlet end of the whirlpool-inducing recirculation pipe 14 causes a fluid that flows out of the whirlpool-inducing recirculation pipe 14 to induce a whirlpool effect within the container into which the fluid is deposited. The whirlpool-inducing recirculation pipe 14 is detachably mounted onto the kettle body 11 so that the user is able to attach the whirlpool-inducing recirculation pipe 14 to the kettle body 11 in a position that facilitates forming a whirlpool with the fluids contained within the kettle. Additionally, the main valve 12, the recirculation valve 13, and the whirlpool-inducing recirculation pipe 14 are in fluid communication with an interior cavity 16 of the kettle body 11. As a result, the main valve 12, the recirculation valve 13, and the whirlpool-inducing recirculation pipe 14 are able to transfer fluids into and out of the interior cavity 16 of the kettle body 11. This functionality enables the user to induce a current within the fluids contained inside the interior cavity 16 of the kettle body 11. The user will be able to thoroughly mix the beer that is being brewed using the present invention; thus, facilitating the chemical reactions that occur during various stages of the brewing process. Specifically, the user is able to connect the main valve 12 to the whirlpool-inducing recirculation pipe 14 while the beer is brewing. To induce a whirlpool effect within the beer, the user pumps the beer out of the interior cavity 16 of the kettle body 11, through the main valve 12, into the whirlpool-inducing recirculation pipe 14, and then back into the interior cavity 16 of the kettle body 11. Alternatively, the user is able to connect the main valve 12 to the recirculation valve 13. The user then pumps the beer out of the out of the interior cavity 16 of the kettle body 11, through the main valve 12, through the recirculation valve 13, and then back into the interior cavity 16 of the kettle body 11. Finally, the user is able to dispense beer stored within the interior cavity 16 of the kettle body 11 by simply opening the main valve 12.

As can be seen in FIG. 1 and FIG. 3, in addition to components for recirculating beer as it brews, the present invention makes use of components for performing the remaining steps of the beer brewing process. To that end, the heating element 15 is mounted within the kettle body 11 so that the user can modify the temperature of the beer being brewed. The support frame 3 is a rigid frame that is used to maintain the plurality of kettles 1 in a desired position while the user is brewing beer. Additionally, the support frame 3 serves as the structure onto which the components of the present invention are mounted. Specifically, the kettle body 11 is mounted onto the support frame 3. As a result, the user is able to position the kettle body 11 in a location that enables the user to maintain the kettle body 11 in a location that lessens the likelihood of the heated kettle body 11 igniting any flammable materials nearby. Additionally, the support frame 3 maintains the plurality of kettles 1 in a position that facilitates the use of the plurality of strainer buckets 2 and the plurality of winches 4. That is, each of the plurality of strainer buckets 2 engages into the interior cavity 16 of a corresponding kettle 19 from the plurality of kettles 1. Consequently, each strainer bucket enables the fluids contained within the interior cavity 16 of the corresponding kettle 19 to inundate a mash mixture that is placed within each strainer bucket. Furthermore, each strainer bucket is designed to act as a sieve for the particulate matter of the mash mixture and prevents the loose pieces of mash from accumulating within the kettle body 11. The plurality of winches 4 is mounted onto the support frame 3, offset from the plurality of kettles 1. Additionally, each of the plurality of winches 4 is tethered to a corresponding bucket 26 from the plurality of strainer buckets 2. Thus connected, each of the plurality of winches 4 facilitates inserting the corresponding bucket 26 into or extracting the corresponding bucket 26 out of the interior cavity 16 of the corresponding kettle 19. That is, each winch is used to raise or lower a single strainer bucket. This enables the user to remove the strainer bucket from within the interior cavity 16 of the kettle body 11 as dictated by the brewing process being used. Each of the plurality of winches 4 is preferably a motorized system.

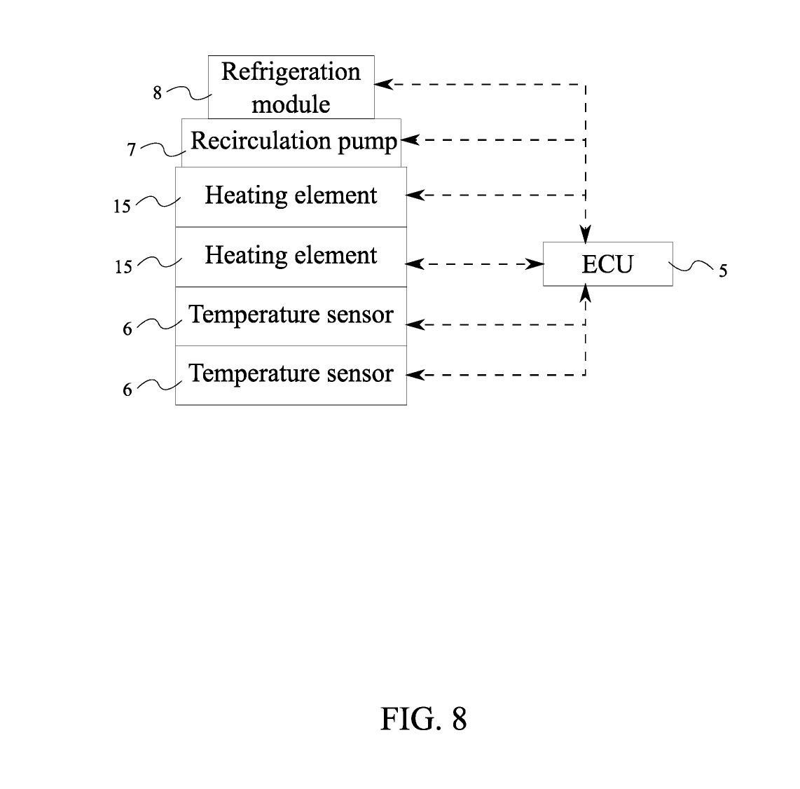

As can be seen in FIG. 1 and FIG. 8, the present invention is designed to function as an automated or semi-automated system. To accomplish this, the present invention further comprises an electronic control unit 5 (ECU). The ECU 5 is a computing device that is capable of executing the steps required to complete the brewing process. The ECU 5 is laterally mounted onto the support frame 3 so that the user is able to easily view and interact with the ECU. Additionally, the ECU 5 is electronically connected to the heating element 15 from each of the plurality of kettles 1. Consequently, the ECU 5 is able to control the temperature of the heating element 15 from each of the plurality of kettles 1.

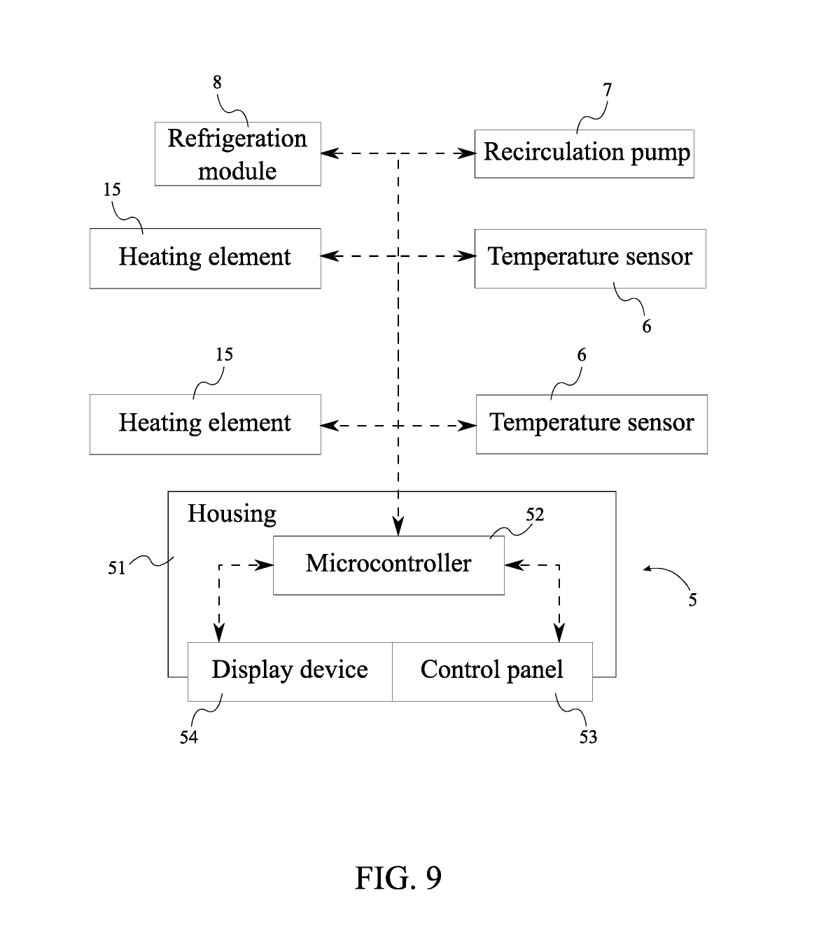

As can be seen in FIG. 1 and FIG. 9, to function as the controller for an automated system, the ECU 5 comprises a housing 51, a microcontroller 52, a control panel 53, and a display device 54. The housing 51 is a rigid enclosure that functions as the structural foundation for the components of the ECU. As such, the microcontroller 52 is mounted within the housing 51 so that the microcontroller 52 is protected from being damaged by water and various other hazards in the external environment. The control panel 53 is a user interface device that enables the user to input commands and modify the settings of the present invention. The display device 54 is an electronic display that visually outputs the system information provided by the microcontroller 52. The control panel 53 is externally mounted onto the housing 51. Additionally, the display device 54 is externally mounted onto the housing 51. Furthermore, the display device 54 is positioned adjacent to the control panel 53. Consequently, the control panel 53 and the display device 54 are maintained in positions that facilitate viewing displayed information and entering user commands. Furthermore, the control panel 53, the display device 54, and each heating element 15 from the plurality of kettles 1 are electronically connected to the microcontroller 52. As a result, the microcontroller 52 is able to send and receive information between these electronic components. Each of the plurality of winches 4 is preferably electronically connected to the microcontroller 52 as well. Thus connected, the microcontroller 52 is able to fully automate the length of time the beer being brewed should be heated and when each of the plurality of strainer buckets 2 should be removed from or inserted into the corresponding kettle 19. To further facilitate granular control of each step in the brewing process, the present invention comprises a plurality of temperature sensors 6. Each of the plurality of temperature sensors 6 is in thermal communication with the corresponding kettle 19. Additionally, the plurality of temperature sensors 6 is electronically connected to the ECU. Consequently, each of the plurality of is able to determine the temperature of the corresponding kettle 19 and report this temperature to the ECU. The ECU 5 can then use this information to monitor the temperature of the beer during each steps of the brewing process.

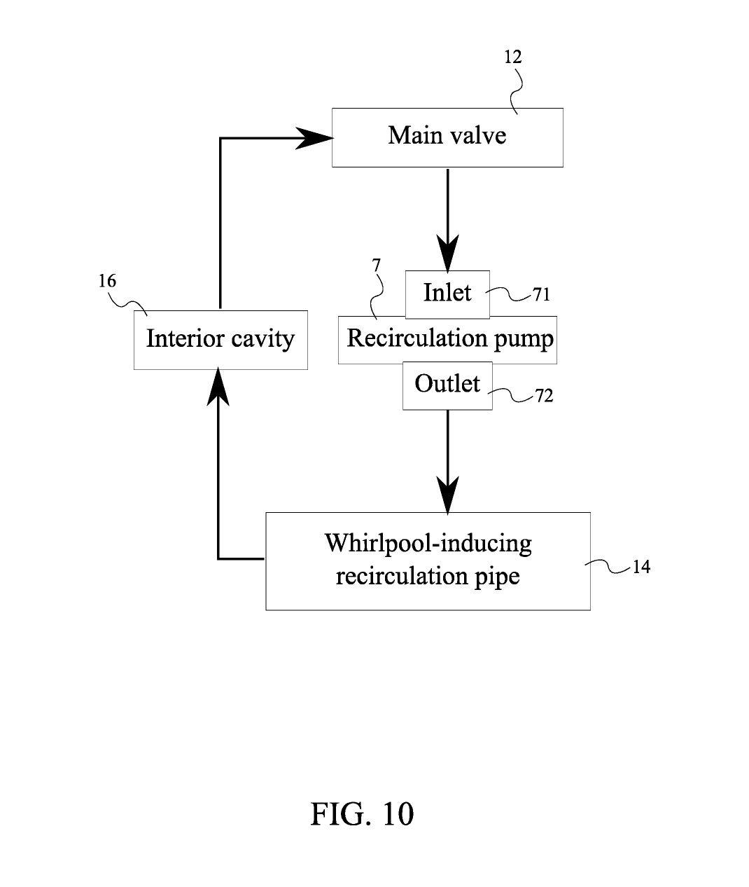

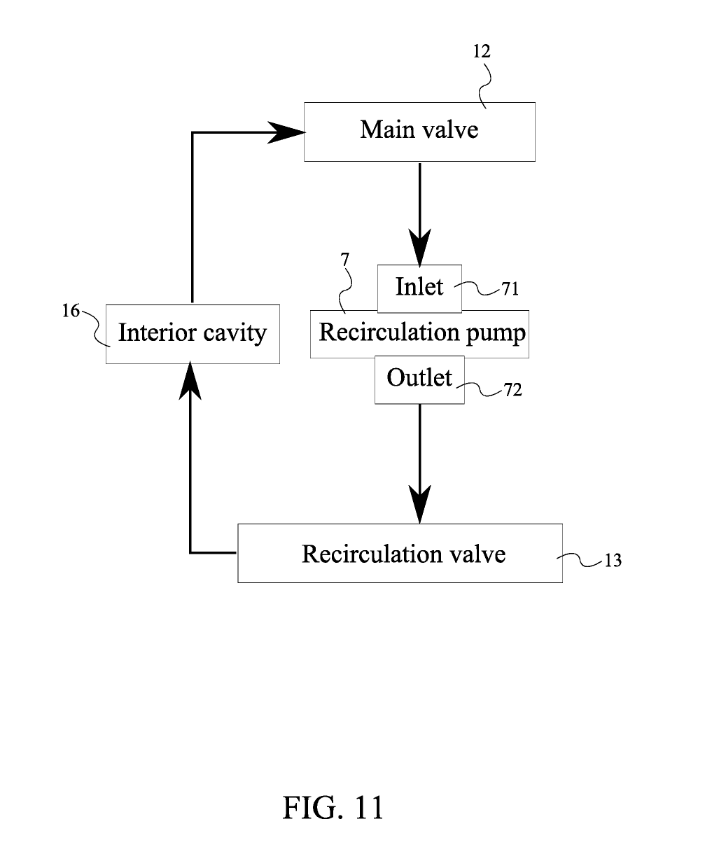

As can be seen in FIG. 1, FIG. 10, and FIG. 11, the present invention is designed to recirculate beer as it is brewing so that the ingredients become thoroughly mixed. To accomplish this, the present invention comprises a recirculation pump 7. The recirculation pump 7 is a pumping system that comprises an inlet 71 and an outlet 72. Additionally, the recirculation pump 7 is in fluid communication with the interior cavity 16 of each of the plurality of kettles 1. As a result, the recirculation pump 7 is able to extract fluid out of the interior cavity 16 of an arbitrary kettle from the plurality of kettles 1 and then deposit said fluid back into the interior cavity 16 of the arbitrary kettle. The recirculation pump 7 is preferably a multichambered system that can be used to recirculate the beer within multiple kettles, simultaneously. As such, the recirculation pump 7 is preferably designed to recirculate fluid at a different flow rate for each one of the plurality of kettles 1. Moreover, the recirculation pump 7 can be interchangeably connected to the main valve 12, the recirculation valve 13 and the whirlpool-inducing recirculation pipe 14 so that the recirculation protocols can be changed during various steps of the brewing process. Specifically, the inlet 71 is in fluid communication with the main valve 12 and the outlet 72 is in fluid communication with the whirlpool-inducing recirculation pipe 14. As a result, this configuration enables the user to induce a whirlpool within the interior cavity 16 of the arbitrary kettle. In a separate configuration, the inlet 71 is in fluid communication with the main valve 12 and the outlet 72 is in fluid communication with the recirculation valve 13. Consequently, the recirculation pump 7 simply creates a current within the interior cavity 16 of the arbitrary kettle. The recirculation pump 7 is electronically connected to the ECU 5 so that the ECU 5 can dictate the flow rate and duration of recirculation cycles.

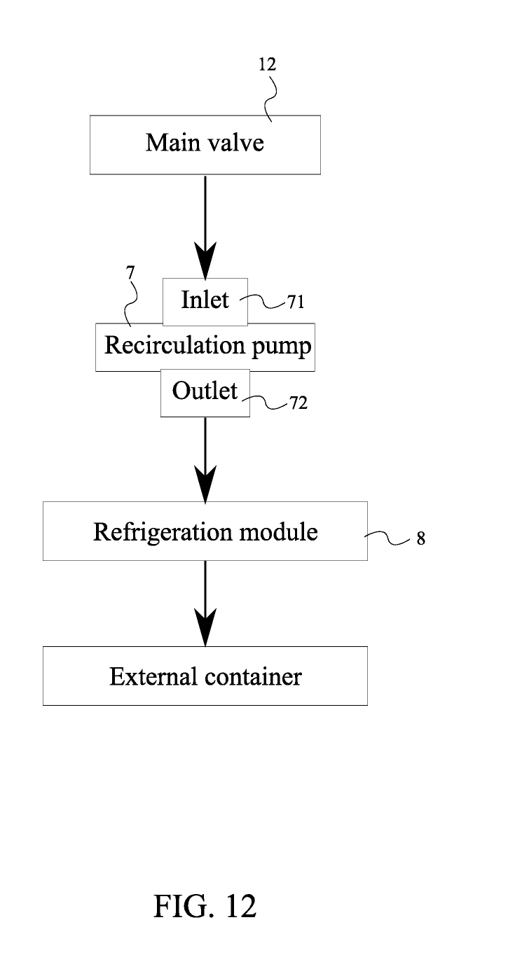

As can be seen in FIG. 1 and FIG. 12, the present invention is designed to not only heat beer during the brewing process, but to cool the beer that is pumped out of the plurality of kettles 1. To accomplish this, the present invention comprises a refrigeration unit 8. The refrigeration unit 8 is an inline wort chiller that cools beer that is pumped out of the plurality of kettles 1 and into fermentation vessels. As such, the refrigeration unit 8 is in fluid communication with the outlet 72. As a result, beer that is pumped out of the recirculation pump 7 must pass through the refrigeration unit before being deposited into a fermentation vessel or any other type of external container; thus, decreasing the temperature of the beer. The refrigeration unit 8 is electronically connected to the ECU 5 so that the ECU 5 is able to govern the functions of the refrigeration unit 8.

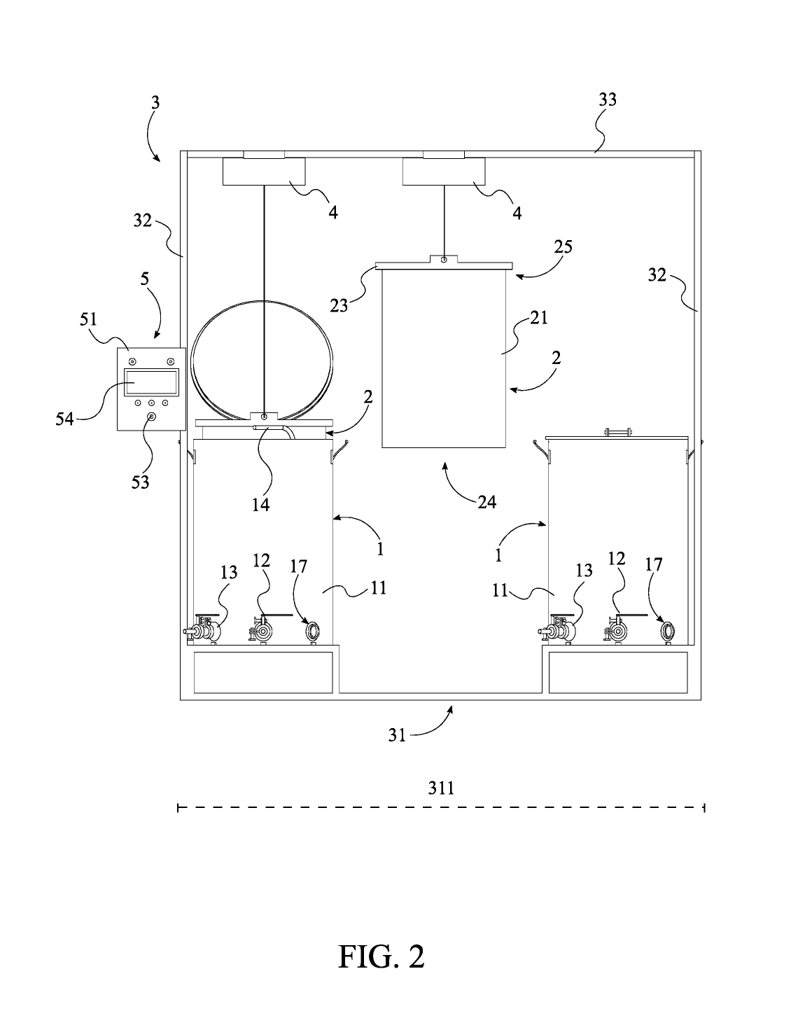

In reference to FIG. 1 and FIG. 2, as described above, the support frame 3 maintains the components of the present invention is positions that facilitate brewing beer. To accomplish this, the support frame 3 comprises a base 31, a plurality of support beams 32, and a winch-adjustment rail 33. The base 31 is a rigid platform onto which the remaining components of the support frame 3 are mounted. As such, each of the plurality of support beams 32 is a strut that extends from the base 31. Specifically, the base 31 is terminally connected to each of the plurality of support beams 32. Additionally, the plurality of support beams 32 is peripherally positioned around the base 31. Furthermore, each of the plurality of support beams 32 is positioned normal to the base 31. Thus positioned, the plurality of support beams 32 forms a vertical frame that is able to support the weight of the plurality of winches 4 and the plurality of strainer buckets 2. In the preferred embodiment of the present invention, the user is able to reposition each of the plurality of winches 4 over the corresponding kettle 19 from the plurality of kettles 1. To accomplish this, the winch-adjustment rail 33 is a rail that is suspended above the base 31. As such, the winch-adjustment rail 33 is terminally connected to each of the plurality of support beams 32, opposite to the base 31. Additionally, the winch-adjustment rail 33 is positioned parallel to a length of the base 311. Finally, the plurality of winches 4 is slidably mounted onto the winch-adjustment rail 33. As a result, the user is able to reposition each of the plurality of winches 4 by sliding each of the plurality of winches 4 along the winch-adjustment rail 33. The plurality of kettles 1 is mounted onto the base 31. Accordingly, the user is able to position each of the plurality of the plurality of winches 4 above the corresponding kettle 19 when brewing beer. Similar to the sliding functionality of the plurality of winches 4, the plurality of kettles 1, preferably, is slidably mounted onto the base 31. To accomplish this, the support frame 3 further comprises a kettle-adjustment rail 34. The kettle-adjustment rail 34 is a rail that enables the user to slide the plurality of kettles 1 along the base 31. As such, the kettle-adjustment rail 34 is mounted onto the base 31. Additionally, the kettle-adjustment rail 34 is positioned parallel to the winch-adjustment rail 33. Furthermore, the plurality of kettles 1 is slidably mounted onto the kettle-adjustment rail 34. Accordingly, the plurality of kettles 1 is maintained in a position that enables the plurality of winches 4 to insert the corresponding strainer bucket into or extract the corresponding strainer bucket out of the corresponding kettle 19.

As can be seen in FIG. 1, FIG. 3, and FIG. 8, each of the plurality of kettles 1 is equipped with additional components that are used to increase ease of use. Specifically, each of the plurality of kettles 1 further comprises an element-receiving receptacle 17, and a sight glass 18. The element-receiving receptacle 17 is a compartment used to store the heating element 15. As such, the element-receiving receptacle 17 traverses into the kettle body 11 so that the heating element 15 can be mounted within the interior cavity 16 of the kettle body 11. Additionally, the heating element 15 engages into the element-receiving receptacle 17. Furthermore, the heating element 15 is in thermal communication with the interior cavity 16. Consequently, the heating element 15 is able to increase the temperature within the interior cavity 16 of the kettle body 11. The sight glass 18 is a device used to view the amount of beer contained within the interior cavity 16 of the kettle body 11. The sight glass 18 is mounted onto a lateral surface of the kettle body 11. Thus positioned, the user is able to visually inspect the sight glass 18 without undue burden. Additionally, the sight glass 18 is in fluid communication with the interior cavity 16. Accordingly, the sight glass 18 is able to give an accurate reading of the amount of beer contained within the interior cavity 16 of the kettle body 11.

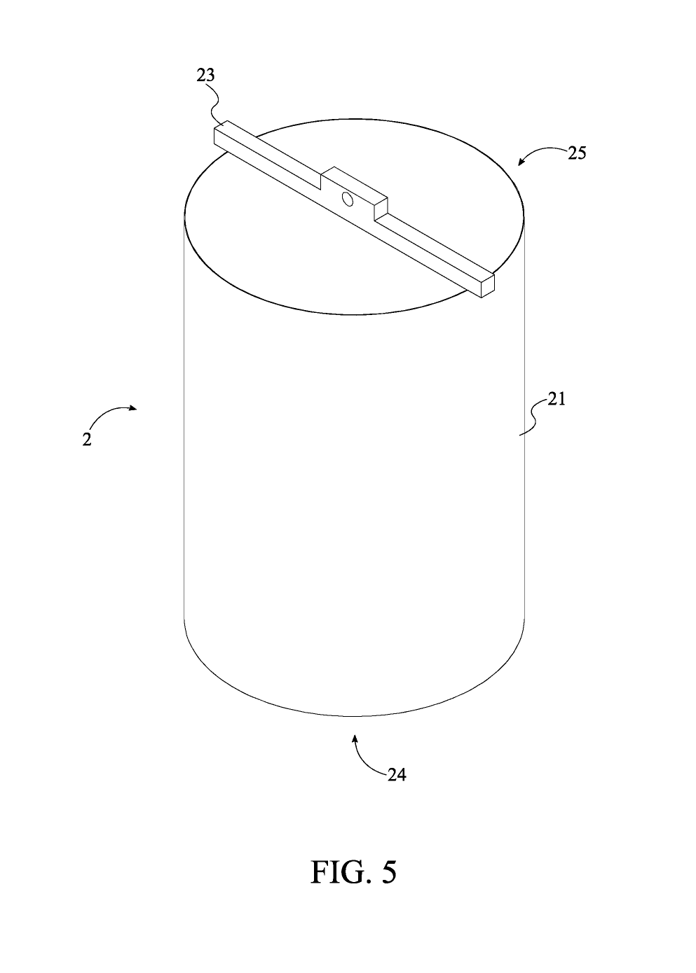

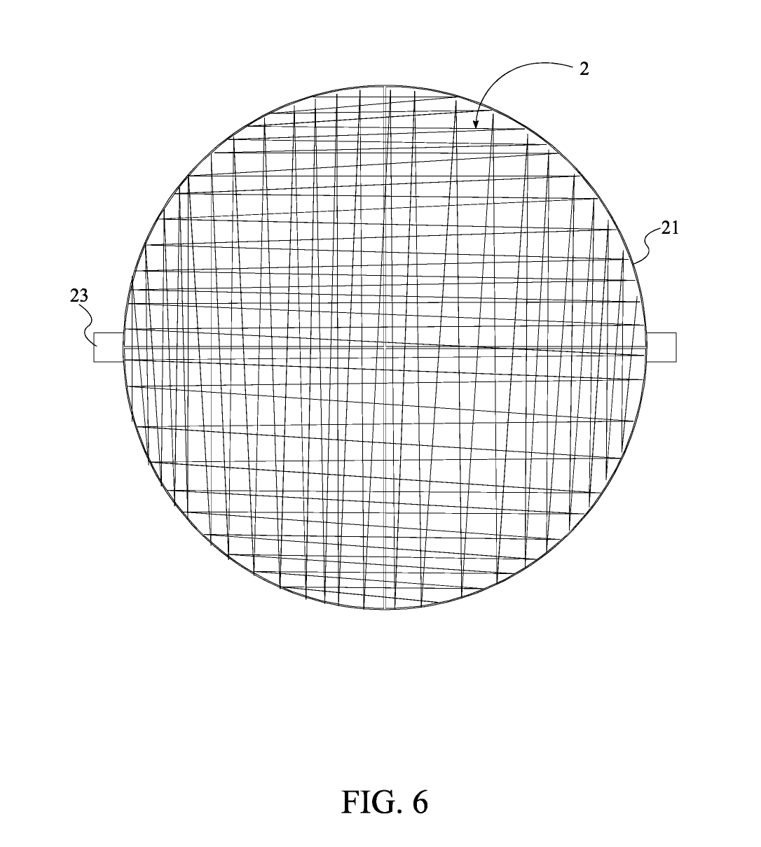

As can be seen in FIG. 1, FIG. 3, FIG. 5, and FIG. 6, the present invention is preferably designed with a hard-sided strainer bucket. The hard-sided strainer bucket encourages the beer being brewed to fully circulate within the interior cavity 16 of the corresponding kettle 19. Specifically, each of the plurality of kettle buckets comprises a hollow tube 21, a mesh endcap 22, and a handle 23. The mesh endcap 22 is adjacently connected to a first end 24 of the hollow tube 21. Additionally, the mesh endcap 22 is positioned across a first opening of the hollow tube 21. As a result, the mesh endcap 22 enables beer to drain out of the hollow tube 21 while removing the mash mixture from inside of the interior cavity 16 of the corresponding kettle 19. The handle 23 is adjacently connected to a second end 25 of the hollow tube 21. Furthermore, the handle 23 is positioned across a second opening of the hollow tube 21. Thus positioned, the handle 23 functions as the mounting point by which the strainer bucket is tethered to a corresponding winch from the plurality of winches 4.

Although the invention has been explained in relation to its preferred embodiment, it is to be understood that many other possible modifications and variations can be made without departing from the spirit and scope of the invention as hereinafter claimed.

What is claimed is:

1. An electric brewing system comprises:
a plurality of kettles;
a plurality of strainer buckets;
a support frame;
a plurality of winches;
each of the plurality of kettles comprises a kettle body, a main valve, a recirculation valve, a whirlpool-inducing recirculation pipe, and a heating element;
the main valve and the recirculation valve being integrated into the kettle body;
the whirlpool-inducing recirculation pipe being detachably mounted onto the kettle body;
the main valve, the recirculation valve, and the whirlpool-inducing recirculation pipe being in fluid communication with an interior cavity of the kettle body;
the heating element being mounted within the kettle body;
the kettle body being mounted onto the support frame;
each of the plurality of strainer buckets engaging into the interior cavity of a corresponding kettle from the plurality of kettles;
the plurality of winches being mounted onto the support frame, offset from the plurality of kettles;
each of the plurality of winches being tethered to a corresponding bucket from the plurality of strainer buckets;

2. The electric brewing system as claimed in claim 1 comprises:
an electronic control unit (ECU);
the ECU being laterally mounted onto the support frame;
the ECU being electronically connected to the heating element from each of the plurality of kettles;

3. The electric brewing system as claimed in claim 2 comprises:
the ECU comprises a housing, a microcontroller, a control panel, and a display device;
the microcontroller being mounted within the housing;
the control panel being externally mounted onto the housing;
the display device being externally mounted onto the housing;
the display device being positioned adjacent to the control panel;
the control panel, the display device, and each heating element from the plurality of kettles being electronically connected to the microcontroller;

4. The electric brewing system as claimed in claim 2 comprises:
a plurality of temperature sensors;
each of the plurality of temperature sensors being in thermal communication with the corresponding kettle;
the plurality of temperature sensors being electronically connected to the ECU;

5. The electric brewing system as claimed in claim 1 comprises:
a recirculation pump;
the recirculation pump being in fluid communication with the interior cavity of each of the plurality of kettles;

6. The electric brewing system as claimed in claim 5 comprises:
the recirculation pump comprises an inlet and an outlet;
the inlet being in fluid communication with the main valve;
the outlet being in fluid communication with the whirlpool-inducing recirculation pipe;

7. The electric brewing system as claimed in claim 5 comprises:
the recirculation pump comprises an inlet and an outlet;
the inlet being in fluid communication with the main valve;
the outlet being in fluid communication with the recirculation valve;

8. The electric brewing system as claimed in claim 5 comprises:
an ECU;
the recirculation pump being electronically connected to the ECU;

9. The electric brewing system as claimed in claim 5 comprises:
an ECU;
a refrigeration unit;
the recirculation pump comprises an outlet;
the refrigeration unit being in fluid communication with the outlet;
the refrigeration unit being electronically connected to the ECU;

10. The electric brewing system as claimed in claim 1 comprises:
the support frame comprises a base, a plurality of support beams, and a winch-adjustment rail;
the base being terminally connected to each of the plurality of support beams;
the plurality of support beams being peripherally positioned around the base;
each of the plurality of support beams being positioned normal to the base;
the winch adjustment rail being terminally connected to each of the plurality of support beams, opposite to the base;
the winch-adjustment rail being positioned parallel to a length of the base;
the plurality of winches being slidably mounted onto the winch-adjustment rail;
the plurality of kettles being mounted onto the base;

11. The electric brewing system as claimed in claim 10 comprises:
the support frame further comprises a kettle-adjustment rail;
the kettle adjustment rail being mounted onto the base;
the kettle-adjustment rail being positioned parallel to the winch-adjustment rail;
the plurality of kettles being slidably mounted onto the kettle-adjustment rail;

12. The electric brewing system as claimed in claim 1 comprises:
each of the plurality of kettles further comprises an element-receiving receptacle;
the element-receiving receptacle traversing into the kettle body;
the heating element engaging into the element-receiving receptacle;
the heating element being in thermal communication with the interior cavity;

13. The electric brewing system as claimed in claim 1 comprises:
each of the plurality of kettles further comprises a sight glass;
the sight glass being mounted onto a lateral surface of the kettle body;
the sight glass being in fluid communication with the interior cavity;

14. The electric brewing system as claimed in claim 1 comprises:
each of the plurality of strainer buckets comprises a hollow tube, a mesh endcap, and a handle;
the mesh endcap being adjacently connected to a first end of the hollow tube;
the mesh endcap being positioned across a first opening of the hollow tube;
the handle being adjacently connected to a second end of the hollow tube;
the handle being positioned across a second opening of the hollow tube;

15. An electric brewing system comprises:
a plurality of kettles;
a plurality of strainer buckets;
a support frame;
a plurality of winches;
an electronic control unit (ECU);
a plurality of temperature sensors;
a recirculation pump;
each of the plurality of strainer buckets comprises a hollow tube, a mesh endcap, and a handle;
each of the plurality of kettles comprises a kettle body, a main valve, a recirculation valve, a whirlpool-inducing recirculation pipe, a heating element, an element-receiving receptacle, and a sight glass;
the support frame comprises a base, a plurality of support beams, and a winch-adjustment rail;
the ECU comprises a housing, a microcontroller, a control panel, and a display device;
the recirculation pump comprises an inlet and an outlet;
the main valve and the recirculation valve being integrated into the kettle body;
the whirlpool-inducing recirculation pipe being detachably mounted onto the kettle body;
the main valve, the recirculation valve, and the whirlpool-inducing recirculation pipe being in fluid communication with an interior cavity of the kettle body;
the heating element being mounted within the kettle body;
the kettle body being mounted onto the support frame;
each of the plurality of strainer buckets engaging into the interior cavity of a corresponding kettle from the plurality of kettles;
the plurality of winches being mounted onto the support frame, offset from the plurality of kettles;
each of the plurality of winches being tethered to a corresponding bucket from the plurality of strainer buckets;
the ECU being laterally mounted onto the support frame;
the ECU being electronically connected to the heating element from each of the plurality of kettles;
the microcontroller being mounted within the housing;
the control panel being externally mounted onto the housing;
the display device being externally mounted onto the housing;
the display device being positioned adjacent to the control panel;
the control panel, the display device, and each heating element from the plurality of kettles being electronically connected to the microcontroller;
each of the plurality of temperature sensors being in thermal communication with the corresponding kettle;
the plurality of temperature sensors being electronically connected to the ECU;
the recirculation pump being in fluid communication with the interior cavity of each of the plurality of kettles;
the inlet being in fluid communication with the main valve;
the outlet being in fluid communication with the whirlpool-inducing recirculation pipe;
the base being terminally connected to each of the plurality of support beams;
the plurality of support beams being peripherally positioned around the base;
each of the plurality of support beams being positioned normal to the base;
the winch adjustment rail being terminally connected to each of the plurality of support beams, opposite to the base;
the winch-adjustment rail being positioned parallel to a length of the base;
the plurality of winches being slidably mounted onto the winch-adjustment rail;
the plurality of kettles being mounted onto the base;
the element-receiving receptacle traversing into the kettle body;
the heating element engaging into the element-receiving receptacle;
the heating element being in thermal communication with the interior cavity;
the sight glass being mounted onto a lateral surface of the kettle body;
the sight glass being in fluid communication with the interior cavity;
the mesh endcap being adjacently connected to a first end of the hollow tube;
the mesh endcap being positioned across a first opening of the hollow tube;
the handle being adjacently connected to a second end of the hollow tube;
the handle being positioned across a second opening of the hollow tube;

16. The electric brewing system as claimed in claim 15 comprises:
the recirculation pump comprises an inlet and an outlet;
the inlet being in fluid communication with the main valve;
the outlet being in fluid communication with the recirculation valve;
the recirculation pump being electronically connected to the ECU;

17. The electric brewing system as claimed in claim 15 comprises:
an ECU;
a refrigeration unit;
the recirculation pump comprises an outlet;
the refrigeration unit being in fluid communication with the outlet;
the refrigeration unit being electronically connected to the ECU;

18. The electric brewing system as claimed in claim 15 comprises:
the support frame further comprises a kettle-adjustment rail;
the kettle adjustment rail being mounted onto the base;
the kettle-adjustment rail being positioned parallel to the winch-adjustment rail;
the plurality of kettles being slidably mounted onto the kettle-adjustment rail;

19. The electric brewing system as claimed in claim 15 comprises:
each of the plurality of strainer buckets comprises a hollow tube, a mesh endcap, and a handle;
the mesh endcap being adjacently connected to a first end of the hollow tube;
the mesh endcap being positioned across a first opening of the hollow tube;
the handle being adjacently connected to a second end of the hollow tube;
the handle being positioned across a second opening of the hollow tube;
